(19) United States
(12) Patent Application Publication
(10) Pub. No.: US 2022/0266206 A1
(43) Pub. Date: Aug. 25, 2022

(54) FORMULATION AND PROCESS FOR MANUFACTURING A HEAT STABLE OIL-IN-WATER EMULSION FOR CANNABIS BEVERAGES IN PLASTIC BOTTLES

(71) Applicant: Gaia Botanicals LLC DBA Bluebird Botanicals, Louisville, CO (US)

(72) Inventors: Tyler T D'Spain, Denver, CO (US); Bethany Kendrick, South Ogden, UT (US)

(21) Appl. No.: 17/180,438

(22) Filed: Feb. 19, 2021

(51) Int. Cl. B01F 3/08; A23L 2/52; A23L 33/105; A23L 29/25

(52) U.S. Cl. CPC B01F 3/0811; A23L 2/52; A23L 33/105; A23L 29/25; B01F 2003/0842; B01F 2003/0849; B01F 2215/0022

(57) ABSTRACT

A novel method for producing a heat stable oil-in-water emulsion for the formulation of cannabinoids in beverages. Such a method provides great utility to expand the types of cannabinoid containing products that may be produced, while ensuring manufacturers are not at risk of perceived under formulation. Known methods used to produce beverages containing cannabinoids, particularly cannabidiol (CBD), are insufficient or inadequate to withstand the high heat often encountered during shipping or storage. One such method of producing a heat stable cannabinoid beverage is presented along with a formulation using said method to produce a CBD energy shot beverage that has been proven to withstand temperatures of up to 45° C. for greater than 17 weeks.

### BACKGROUND OF THE INVENTION

### Field of Invention

The present general inventive concept is directed to a method of manufacture of a cannabis extract-containing beverage that maintains cannabis potency during prolonged exposure to warm environments commonly experienced during transportation and storage.

### Description of the Related Art

Analysis of CBD-based consumer beverages shows a discrepancy between manufacturer's stated CBD content claims and the amount of CBD contained in the product at the time of sale. From initial experimentation, the reduction in CBD concentration occurs most often when beverages are stored in plastic. This phenomenon has been found to be exacerbated when the product is stored or transported at temperatures greater than room temperature, approximately 25° C. This change has been observed when products are shipped during hot summer months or stored in hot warehouses. In one instance, products tested under accelerated shelf-life study conditions, 45° C. and 75% relative humidity, revealed that measured CBD content dropped by greater than 40% in just 48 hours. The CBD was found to have migrated out of solution and adsorbed onto the interior of the plastic container. The discovery that CBD was adhering to the plastic container guided the present invention. Using known means of production with food-grade gums or emulsifiers results in diminished potency. Potency testing conducted after the solution is stored in plastic and exposed to heat greater than about 35° C. (but even faster at temperatures above 40° C.) reveals reduced potency. It is also normal for products to experience higher temperatures due to seasonal changes and storage or shipment in non-climate-controlled environments. It has been determined that a leading cause of the decrease of potency is that under normal circumstances, a cannabis beverage that was formulated with an accurate dose of active ingredient my lose as much as 50% of its active ingredient to the plastic container before it has reached the end user.

There are other known methods for formulating cannabinoid products, but none adequately address the issue regarding plastic adhesion at elevated temperatures. Numerous vendors sell a variety of food grade gums, hydrocolloids, and surfactants but none appear to provide the adequate emulsification of CBD for beverage applications without special techniques in the manufacturing process. In some cases, changing packaging to glass may yield some improvement but the benefits of plastic packaging such as strength, light weight, and cost are lost. What is needed is a method for producing cannabinoid containing beverages wherein the potency does not decrease substantially over time even under real-world storage conditions.

### SUMMARY OF THE INVENTION

It is an aspect of the present invention to provide a method of manufacturing a heat stable water-based cannabis beverage containing an oil in water emulsion that retains consistent levels of active ingredient, even at elevated temperatures, without the use of traditional surfactants. The above aspects can be obtained by a method comprising the steps of preparing a gum mixture by homogenizing water and a gum blend comprising acacia gum and modified acacia gum to create a gum mixture, preparing an oil phase by dissolving a cannabis extract in a carrier oil with other oil soluble ingredients, creating an emulsion by homogenizing the oil phase into the gum mixture, then adding additional water and water-soluble ingredients and mixing to produce a homogenized product.

It is a particular aspect of the invention to provide formulation for delivering cannabinoids as part of an energy shot beverage consisting of cannabidiol (CBD), caffeine, monk fruit extract, stevia extract, citric acid, sodium chloride, sodium benzoate, potassium sorbate, methylcobalamin, natural flavor, modified acacia gum (e.g. TICAmulsion 3020), fractionated coconut oil, lemongrass essential oil, mixed tocopherols, and water.

### BRIEF DESCRIPTION OF THE DRAWINGS

FIG. 1 presents a diagram of the method steps and intermediates of the preferred embodiment.

FIG. 2 presents a graph of the measured CBD concentration over time in a composition produced in an embodiment of the invention.

### DESCRIPTION OF THE PREFERRED EMBODIMENTS

Reference will now be made in detail to the presently preferred embodiments of the invention, including the production of the stable cannabinoid emulsion and the application of said emulsion in the formulation of a CBD energy shot beverage. The present initiative relates to a method for producing a stable oil-in-water emulsion containing cannabinoids that maintains consistent cannabinoid concentration when stored in a plastic container at temperatures up to 45° C.

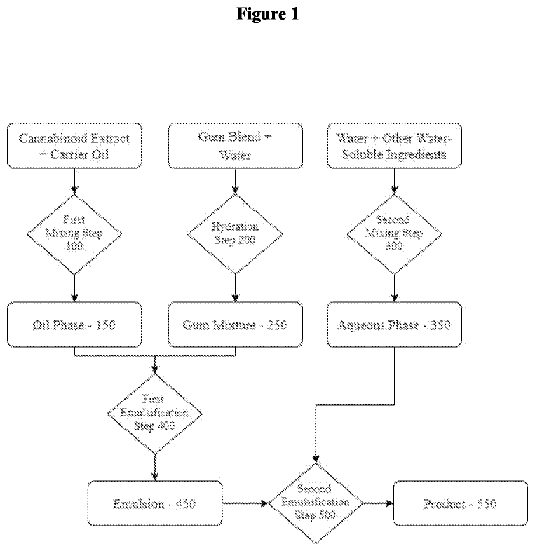

Detailed description of the method of the invention will be made with reference to FIG. 1. FIG. 1 presents a flow chart of a method of producing an emulsion composition that is stable for use in plastic bottles. First mixing step 100 can comprise combination of a cannabinoid extract with a carrier oil to produce oil phase 150. Hydration step 200 can comprise combination of gum blend and water to produce gum mixture 250. Second mixing step 300 can comprise a combination of water and other water-soluble ingredients to produce aqueous phase 350. Oil phase 150 and gum mixture 250 can be combined in first emulsification step 400 to provide emulsion 450. Emulsion 450 can be combined with aqueous phase 350 in second emulsification step 500 to produce product 550. As will be described below, component selection can be altered to produce superior results over the prior art.

In first mixing step 100, cannabinoid extract may be advantageously dissolved into a carrier oil to create oil phase 150. An aspect of the current invention is the use of a carrier oil, which overcomes the issues of aqueous solubility for the cannabinoid extract, particularly CBD. In its pure form, CBD is a non-polar crystalline solid which in the absence of an oil or alcohol will not readily dissolve to form a stable emulsion with the gum blend. By dissolving the CBD in a carrier oil in first mixing step 100, the CBD will be readily dissolved into the oil which increases its suitability for emulsion formation. In an embodiment of the invention, CBD is added to fractionated coconut oil (MCT oil) in first mixing step 100 using an immersion blender to thoroughly mix, then the mixture is transferred to a magnetic stir plate to allow for slow gentle mixing of the oil until the CBD is completely dissolved. First mixing step 100 can comprise immersion blending at a high shear rate followed by a slower mixing utilizing a stir bar. Heat may be used to speed the process but may result on oxidation of the CBD as well as result in off-flavors. MCT oil offers several advantages over other possible carrier oils as it is both colorless and nearly flavorless, and it readily dissolves CBD at concentrations as high as 30%. The high solubility and mild color and flavor of MCT oil are favorable characteristics for utilization in creation of oil phase 150 in an embodiment of the invention.

In hydration step 200, a gum blend is hydrated by dispersing in water and thoroughly homogenized using a high shear mixer. In one such embodiment, the gum blend and water are homogenized using an immersion blender until the mixture appears consistent and opaque. Hydration step 200 produces gum mixture 250. In one such embodiment, the gum blend consists of acacia gum and modified acacia gum, where part of the branched polysaccharide is modified with octenylsuccinic acid anhydride (OSAN) to improve emulsifying properties. In one preferred embodiment of the invention, the mixture of acacia gum and OSAN-modified acacia gum is provided by a product TICAmulsion 3020 available from TIC Gums at TICGums.com. The TICAmulsion 3020 gum blend was found to consistently produce stable emulsions with excellent solubility and minimal added flavor or fragrance. It has been found that acacia gum along with OSAN-modified acacia gum provides superior emulsification of heavy oil loads and allows for a larger portion of the total formulation to be composed of oil soluble ingredients. The ability to provide an emulsion with a high oil content is advantageous in the present invention as it allows for greater flexibility in terms of dose for oil soluble active ingredients and total volumes necessary to provide one serving of said active ingredient. A high concentration of active ingredients is critical in “shot” formats of small liquid volumes, approximately two fluid ounces. Use of acacia gum and modified acacia gum were found to provide increased stability. Other gums, such as xanthan gum and guar gum may be used in place of or in addition to the acacia gum blend. It has been found that a ratio of 1:3 on a weight basis in the emulsion 450 of TICAmulsion 3020 to water yielded the greatest emulsion stability, which is used in the embodiment of Example 1.

Second mixing step 300 employs mixing of additional water-soluble ingredients which may include but is not limited to sweeteners, preservatives, and flavoring agents are dissolved into water to form aqueous phase 350. Aqueous phase 350 serves to provide the additional water necessary to dilute to emulsion to a level that is palatable to the average consumer and does not appear to significantly affect stability. Second mixing step 300 may be advantageously employed to create a variety of products 550 starting with the same emulsion 450 and varying the ingredients only in the aqueous phase 350 prior to the second emulsification step 500.

In first emulsification step 400, the oil phase 150 and gum mixture 250 are combined to form the emulsion 450. The emulsion 450 is formed through high shear mixing of said oil phase 150 and gum mixture 250. High shear mixing aids in dispersing the components and reducing clumping, which allows for the optimal contact of water, gum, and oil for emulsion formation. In a preferred embodiment, an immersion blender is used for high shear mixing of oil phase 150 and gum mixture 250 to form emulsion 450.

The process of high shear mixing is repeated in second emulsification step 500 to combine emulsion 450 and aqueous phase 350. It is advantageous in second emulsification step 500 to employ high shear mixing for emulsion formation and low shear mixing to ensure full contact with the high shear mixer, given the increase in volume. In an embodiment of the invention, second emulsification step 500 is accomplished using a paddle to mix the components while using an immersion blender to promote emulsification to yield product 550.

To determine the optimal ratio of each phase combined to create emulsion 450 and product 550, ratios of each phase were varied and tested for sensory characteristics as well as potency loss under heated storage conditions. To determine preferred sensory characteristics each variation was assessed for fragrance, flavor, and mouthfeel. To determine the resistance to potency loss, each variation of product 550 was stored at 45° C. for 7 days, and then analyzed for cannabinoid content. Potency was measured against initial or intended concentrations. At creation, potency is expected to be 100% of intended concentration. Tables 1 and 2 present data from analysis of several representative products produced. The Preferred Ratio is the ratio of ingredients in the emulsion 450 applied in a preferred embodiment of the invention and was produced by the process described above. All stated ingredient ratios are based on ingredient concentrations in the emulsion 450. Each variation was subjected to emulsification step 500 which was unchanged for all variations. Variation 1 and Variation 2 in Table 1 are representative of the trends observed by varying concentrations of each of the three components of the emulsion 450. Variation 1 differs from the Preferred Ratio only by the ratio of oil phase 150. The general observation from varying the oil phase was a minimal variation in potency stability, particularly when using a smaller ratio of oil, while increasing the ratio of oil by as much as two-fold showed an acceptable level of potency stability, but resulted in a noticeable decrease in palatability and mouthfeel due to the high concentration of oil. Variation 2 differs from Variation 1 only by the amount of water added in hydration step 200. A significant decrease in potency stability was observed when the ratio of water to oil phase in the emulsion 450 dropped below 3:1. The observation from Variation 2 further justified the Preferred Ratio, which contains a ratio of 6 parts water to 1 part oil phase. The water to oil phase ratio of 6:1 yielded an ideal balance of oil load for the addition of maximum active ingredient, while yielding excellent potency stability and favorable flavor and mouthfeel. With the Preferred Ratio composition selected, the experiments above were repeated to test if a commonly applied food grade surfactant, Tween 80, could further improve the stability of the preferred embodiment. In Table 2, the Preferred+Tween 80 represents a composition of the Preferred Ratio composition with the addition the manufacturer's suggested concentration of surfactant. While common in this type of beverage, addition of Tween 80 both failed to improve stability and significantly decreased palatability due to the bitterness of the surfactant.

TABLE 1
CBD Potency Accuracy After 7 Days at 45° C.
for Three Variants of Product 550

| Ingredient | Preferred | Variation 1 | Variation 2 |
|---|---|---|---|
| TICAmulsion 3020 | 2 | 1 | 1 |
| Water | 6 | 3 | 2.5 |
| Oil Phase | 1 | 1 | 1 |
| Potency Accuracy | 98.57% | 95.48% | 79.40% |

TABLE 2
CBD Potency Accuracy After 7 Days at 45° C. in Preferred
Embodiment with and without the Addition of Surfactant (Tween 80)

| Ingredient | Preferred Ratio | Preferred + Tween 80 |
|---|---|---|
| TICAmulsion 3020 | 2 | 2 |
| Water | 6 | 6 |
| Oil Phase | 1 | 1 |
| Emulsifier | — | 0.1 |
| Potency Accuracy | 98.57% | 92.75% |

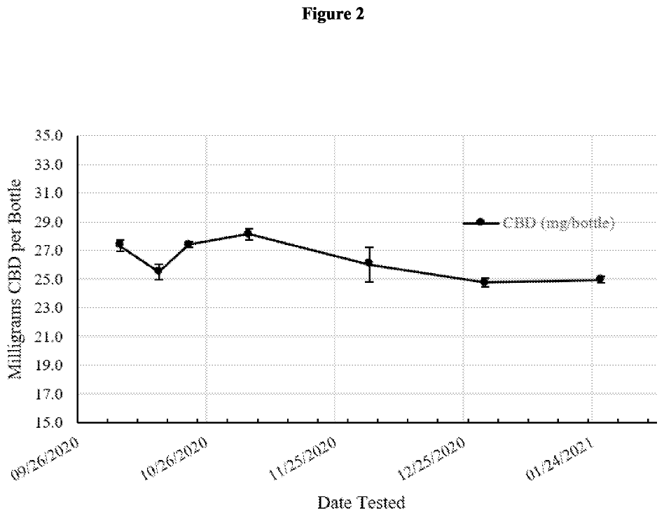

To test performance of the invention and its ability provide a cannabinoid beverage capable of withstanding heat for a significant duration, the following experiment was designed to test resistance to potency loss under long-term high heat storage conditions. The long-term stability performance of a product 550 of the present invention was tested by preparing three lots of the embodiment of formulation and method Example 1 below, which were transferred to 57 mL PET bottles for storage. One bottle of each lot was tested for CBD concentration by an ISO 17025 accredited testing laboratory to confirm the initial potency. The remaining bottles were stored in an accelerated stability chamber. The stability chamber maintains a temperature of 45±2° C. and relative humidity of 75±5%. One bottle of each lot was pulled from the chamber after elapsed time of 1 week, 2 weeks, 5 weeks, 9 weeks, 13 weeks, and 17 weeks to simulate excessive high temperature long-term storage conditions for greater than four months. At each interval, the three bottles were tested for CBD concentration. The results are presented in graphical form in FIG. 2. The error bars represent two times the standard deviation of the three measurements. The stability data of FIG. 2 shows the efficacy of the present invention, as well as its application in the CBD energy shot beverage produced according to Example 1.

It is a particular aspect of the invention to provide a formulation and method of manufacture for a CBD energy shot beverage capable of maintaining consistent levels of CBD at elevated temperatures. In a particular embodiment of the invention, the beverage consists essentially of approximately 80-97% water; approximately 0.16-0.64% TICAmulsion 3020; approximately 0.11-0.13% fractionated coconut oil; approximately 0.04-0.05% CBD; approximately 1.4-2.0% natural flavor; approximately 0.30-0.34% citric acid; approximately 0.28-0.30% caffeine; approximately 0.19-0.21% monk fruit extract; approximately 0.19-0.21% stevia extract; approximately 0.05-0.06% sodium chloride; approximately 0.02-0.03% sodium benzoate; approximately 0.02-0.03% potassium sorbate; approximately 0.004-0.005% mixed tocopherols; approximately 0.0039-0.0041% lemongrass essential oil; and approximately 0.0001-0.0002% methylcobalamin. The flavor of the product 550 in this embodiment is based on a natural berry flavor. Additional flavors may be achieved in the method of the invention including lemon-lime, orange, or grape flavoring at varying amounts where the flavoring is water-soluble. Monk fruit and stevia extracts can be added for natural sweetness and the flavor is balanced with salt (sodium chloride).

Lemongrass essential oil can be added as a natural bitter blocker to improve the overall flavor and reduce the perceived bitterness of caffeine. The amount of lemongrass oil added was found to be advantageous as too little led to bitter off flavors, while too much produced a noticeable grassy taste that does not mix well with the included berry flavor. For shelf stability, a mixture of sodium benzoate and potassium sorbate, which may be replaced with equal amounts of potassium benzoate and sodium sorbate respectively, can be added to prevent bacterial and fungal growth, while mixed tocopherols (vitamin E) can be added as an antioxidant to reduce the oxidation of oil soluble ingredients, such as CBD. Methylcobalamin (vitamin B12) and caffeine were formulated within industry standard concentrations for energy supplements, and CBD was formulated to provide a dose of 25 mg per serving, which is within the industry range of approximately 5 to 50 mg per serving.

As made evident above, the amounts of water, MCT oil, and TICAmulsion 3200 were found to be advantageous to the creation of a long-term stabile product with increased durability of active ingredient concentration. Within experimentation, the addition of various oil soluble ingredients to oil phase 150 did not prove detrimental to long-term stability, which provides a suitable platform to produce similar beverages with a wide range of oil soluble ingredients. One application of the particular aspect of the invention stated above is presented in Example 1.

### Example 1: Method of Manufacturing a 25 Gallon Batch of CBD Energy Shot Beverage

In one particular embodiment of the invention, the following steps of the method were employed to produce product 550. In first mixing step 100, 46.0-47.0 g of cannabidiol (CBD) was added to 106.0-107.0 g of fractionated coconut oil. Mixing is conducted for about 2 minutes with an immersion blender to disperse the CBD into the oil, then a PTFE magnetic stir bar is added, and the mixture is allowed to mix on a magnetic stir plate until the CBD is fully dissolved, for approximately 45 minutes. As CBD will slowly dissolve into the MCT oil, a low energy mixing technique is preferred to keep the mixture from being heated by the mixer. The result of first mixing step 200 is oil phase 150 (approx. 153 g).

In hydration step 200, 305-308 g of TICAmulsion 3200 (gum blend) was added to 916-918 g of water and the gum blend was dispersed in the water and thoroughly homogenized using an immersion blender until the mixture appears consistent and opaque, similar to milk. Hydration step 200 produces gum mixture 250.

In second mixing step 300, 89.60-89.68 kg of water was added to a 60-gallon steam kettle, followed by additional water-soluble ingredients, including 264-266 g of caffeine, 0.176-0.180 g of methylcobalamin, 182-185 g of stevia extract, 182-185 g of monk fruit extract, 303-306 g of citric acid, 56-58 g of sodium chloride, 24-36 g of sodium benzoate, 24-36 g of potassium sorbate, and 1360-1365 g of natural berry flavor. A steam kettle was used to heat the mixture to between 60° C. and 80° C. while mixing gently with a stainless steel paddle until all solids are dissolved, about 25 minutes, then the heat is turned off and the solution allowed to cool to 40° C. or less, preferably between 20-30° C. Second mixing step 300 produces aqueous phase 350.

In first emulsification step 400, gum mixture 250 and oil phase 150 are transferred to a vessel to combine along with 3.7-3.9 g of lemongrass essential oil, and 3.7-3.9 g of mixed tocopherols, and the mixture is emulsified using an immersion blender or other high-shear mixing technique for approximately 5 minutes, or until the mixture is visually homogenous with a consistent viscosity. The use of high-shear mixing is critical to ensure oil phase 150 is adequately dispersed with gum mixture 250 to create a stable emulsion. First emulsification step 400 produces emulsion 450. The Preferred Ratio of ingredients is achieved at this point containing TICAmulsion 3200 (306.5 g), water (917 g), and oil phase (153 g) for a ratio of approximately 2:6:1.

In second emulsification step 500, emulsion 450 is transferred to a steam kettle along with aqueous phase 350 and mixed with an immersion blender for between 5 and 10 minutes. If needed, additional stirring may be performed to fully disperse emulsion 450 into aqueous phase 350 while immersion blending. Once fully emulsified, product 550 should appear nearly clear, indicating the oil-in-water emulsion is adequately dispersed in the water phase. If clumps appear or the mixture is opaque or cloudy, the solution must be further processed with an immersion blender or another high-shear mixer until clear. Product 550 in this example provides a heat stable CBD energy shot beverage that may be packaged into appropriate containers, preferably a 2 fluid ounce polyethylene terephthalate (PET) or polypropylene (PP) bottle, based on common packaging available for this type of product. Product 550 shows increased stability in plastic packaging over time.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method of producing a heat stable cannabis beverage containing an oil-in-water emulsion comprising the steps of:
preparing a gum mixture by homogenizing water and gum blend;
preparing an oil phase by dissolving a cannabis extract in a carrier oil;
creating an emulsion by homogenizing said gum mixture and said oil phase;
diluting said emulsion by adding water and mixing.

2. The method of claim 1, wherein said gum blend is acacia gum and modified acacia gum.

3. The method of claim 1, wherein said gum blend comprises acacia gum and acacia gum modified with octenylsuccinic acid anhydride.

4. The method of claim 1, wherein said gum blend is used in a 1:3 ratio of gum blend to water in the emulsion.

5. The method of claim 1, wherein said cannabis extract is cannabidiol.

6. The method of claim 1, wherein said carrier oil is fractionated coconut oil (MCT oil).

7. A beverage produced by the method of claim 1, consisting essentially of:
approximately 80-97% water.
approximately 0.16-0.64% TICAmulsion 3020;
approximately 0.11-0.13% fractionated coconut oil;
approximately 0.04-0.05% cannabidiol;
approximately 1.4-2.0% natural flavor;
approximately 0.30-0.34% citric acid;
approximately 0.28-0.30% caffeine;
approximately 0.19-0.21% monk fruit extract;
approximately 0.19-0.21% stevia extract;
approximately 0.05-0.06% sodium chloride;
approximately 0.02-0.03% sodium benzoate;
approximately 0.02-0.03% potassium sorbate;
approximately 0.004-0.005 mixed tocopherols;
approximately 0.0039-0.0041% lemongrass essential oil
and approximately 0.0001-0.0002% methylcobalamin.

8. A beverage of claim 7, wherein said natural flavor consists of water-soluble berry, lemon-lime, orange, or grape flavor.
